(19) United States
(12) Patent Application Publication
(10) Pub. No.: US 2020/0127588 A1
(43) Pub. Date: Apr. 23, 2020

(54) SYMMETRIC CONTROL OF AN ASYMMETRIC AC MOTOR VIA A FLUX REGULATOR OPERATING BASED ON A TARGETED TIME CONSTANT VERSUS SAMPLING PERIOD RATIO

(71) Applicant: GM Global Technology Operations LLC, Detroit, MI (US)

(72) Inventors: Caleb W. SECREST, Oakland Township, MI (US); Dwarakanath V . SIMILI, Oakland Township, MI (US); Yo Chan SON, Rochester Hills, MI (US)

(73) Assignee: GM Global Technology Operations LLC, Detroit, MI (US)

(21) Appl. No.: 16/165,538

(22) Filed: Oct. 19, 2018

(51) Int. Cl. H02P 21/00; H02P 21/14; H02P 21/22; H02P 27/08

(52) U.S. Cl. CPC H02P 21/0003; H02P 21/14; B60L 11/1803; H02P 27/08; H02P 21/22

(57) ABSTRACT

A control system for controlling operation of an asymmetric motor to operate as a symmetric motor is provided and includes first and second summers, a proportional flux error-to-voltage converter, a complex integration module, and a control module. The first summer determines a flux error for d and q axes of the asymmetric motor based on a commanded flux value and a feedback flux value. The proportional flux error-to-voltage converter converts the flux error to a proportional voltage term. The complex integration module, based on a time constant, a synchronous angular velocity, and a sampling period, calculates an integral voltage term. The second summer sums the proportional voltage term, the integral voltage term, and a damping resistance voltage to generate a voltage command signal. The damping resistance voltage is based on first and second damping resistances. The control module controls operation of the asymmetric motor based on the voltage command signal.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to asymmetric alternating current (AC) motors, and more particularly to circuits for controlling operation of asymmetric AC motors.

Electric machines are utilized in a wide variety of applications. For example, hybrid electric vehicles (HEVs) typically include an electric traction drive system that includes a multi-phase alternating current (AC) motor. The AC motor is driven by a power inverter, which receives power from a direct current (DC) power source, such as a storage battery. The inverter converts a DC voltage to an AC voltage, which is then used to drive the AC motor to turn a shaft of a HEV drivetrain.

One or more AC motors may be implemented on a vehicle. The AC motors may be asymmetric motors, such as interior permanent magnet synchronous motors (IPMSMs). IPMSMs are used in high performance applications because of high corresponding power density and efficiency ratings.

### SUMMARY

A control system for controlling operation of an asymmetric motor to operate as a symmetric motor is provided. The control system includes a memory, a first summer, a proportional flux error-to-voltage converter, a complex integration module, a second summer, and a control module. The memory is configured to store a time constant, a first damping resistance for a d-axis of the asymmetric motor, and a second damping resistance for a q-axis of the asymmetric motor. The first summer is configured to determine a flux error for the d-axis and the q-axis of the asymmetric motor based on a commanded flux value and a feedback flux value. The proportional flux error-to-voltage converter is configured to convert the flux error to a proportional voltage term. The complex integration module is configured to, based on the time constant, a synchronous angular velocity of the asymmetric motor, and a sampling period, calculate an integral voltage term. The second summer is configured to sum the proportional voltage term, the integral voltage term, and a damping resistance voltage to generate a voltage command signal, where the damping resistance voltage is based on the first damping resistance and the second damping resistance. The control module is configured to control operation of the asymmetric motor based on the voltage command signal.

In other features, the control system further includes a regulator configured to calculate the time constant based on the sampling period for sampling current or flux of the asymmetric motor, where the regulator includes the proportional flux error-to-voltage converter, the complex integration module, and the second summer.

In other features, the control system further includes a regulator configured to calculate the damping resistance voltage based on at least one of the time constant, an amount of current associated with the d-axis, an amount of current associated with the q-axis, one or more partial derivatives of surface flux maps, an amount of flux associated with the d-axis, an amount of flux associated with the q-axis, or an actual resistance of the asymmetric motor, where the regulator includes the proportional flux error-to-voltage converter, the complex integration module, and the second summer.

In other features, the control system further includes a regulator configured to calculate the damping resistance voltage based on the time constant, an amount of current associated with the d-axis, an amount of current associated with the q-axis, an amount of flux associated with the d-axis, an amount of flux associated with the q-axis, and an actual resistance of the asymmetric motor, where the regulator includes the proportional flux error-to-voltage converter, the complex integration module, and the second summer.

In other features, the control module is configured to operate the asymmetric motor to provide a modified plant representation of the asymmetric motor of

$$\frac{1}{s + {τ}_{mod}^{- 1} + j {ω}_{e}}$$

in the Laplace domain, where τ_{mod} is the time constant and ωₑ is the synchronous angular velocity.

In other features, the proportional flux error-to-voltage converter is configured to generate the proportional voltage term based on a preselected bandwidth.

In other features, the complex integration module is configured to modify the proportional voltage term by an amount of gain and discrete integration process. The amount of gain is based on the time constant, the synchronous angular velocity and the sampling period.

In other features, the control module is configured to operate the asymmetric motor based on a first flux based linearized machine equation for the d-axis and a second flux based linearized equation for the q-axis. The first flux based linearized machine equation and the second flux based linearized equation are in a same form as symmetric machine equations.

In other features, the control system further includes a regulator configured to regulate operation of the asymmetric motor using a same time constant to sampling period ratio for each of the d-axis and the q-axis. The regulator includes the proportional flux error-to-voltage converter, the complex integration module, and the second summer.

In other features, the control system further includes: a current module configured to estimate an amount of d and q axes current for a next sample time subsequent to a current sample time; and a current-to-flux converter configured to convert the estimated amount of d and q axes current to the feedback flux value. The feedback flux value is an amount of flux for the d and q axes.

In other features, a method of controlling operation of an asymmetric motor to operate as a symmetric motor is provided. The method includes: calculating a time constant, a first damping resistance for a d-axis of the asymmetric motor, and a second damping resistance for a q-axis of the asymmetric motor; determining a flux error for the d-axis and the q-axis of the asymmetric motor based on a commanded flux value and a feedback flux value; converting the flux error to a proportional voltage term; based on the time constant, a synchronous angular velocity of the asymmetric motor, and a sampling period, modifying the proportional voltage term to provide an integral voltage term; summing the proportional voltage term, the integral voltage term, and a damping resistance voltage to generate a voltage command signal, where the damping resistance voltage is based on the first damping resistance and the second damping resistance; and controlling operation of the asymmetric motor based on the voltage command signal.

In other features, the method includes calculating the time constant based on the sampling period for sampling current or flux of the asymmetric motor.

In other features, the method includes calculating the damping resistance voltage based on at least one of the time constant, an amount of current associated with the d-axis, an amount of current associated with the q-axis, one or more partial derivatives of surface flux maps, an amount of flux associated with the d-axis, an amount of flux associated with the q-axis, or an actual resistance of the asymmetric motor.

In other features, the method includes calculating the damping resistance voltage based on the time constant, an amount of current associated with the d-axis, an amount of current associated with the q-axis, an amount of flux associated with the d-axis, an amount of flux associated with the q-axis, and an actual resistance of the asymmetric motor.

In other features, the method further includes operating the asymmetric motor to provide a modified plant representation of the asymmetric motor of

$$\frac{1}{s + {τ}_{mod}^{- 1} + j {ω}_{e}}$$

in the Laplace domain, where τ_{mod} is the time constant and ωₑ is the synchronous angular velocity.

In other features, the method further includes generating the proportional voltage term based on a preselected bandwidth.

In other features, the method includes modifying the proportional voltage term by an amount of gain and discrete integration process, where the amount of gain is based on the time constant, the synchronous angular velocity and the sampling period.

In other features, the method further includes operating the asymmetric motor based on a first flux based linearized machine equation for the d-axis and a second flux based linearized equation for the q-axis, where the first flux based linearized machine equation and the second flux based linearized equation are in a same form as symmetric machine equations.

In other features, the method further includes regulating operation of the asymmetric motor using a same time constant to sampling period ratio for each of the d-axis and the q-axis.

In other features, the method further includes: estimating an amount of d and q axes current for a next sample time subsequent to a current sample time; and converting the estimated amount of d and q axes current to the feedback flux value, where the feedback flux value is an amount of flux for the d and q axes.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a control system incorporating a motor control module in accordance with the present disclosure;

FIG. 2 is a top cross-sectional simplified view of a conceptual diagram of an an IPMSM illustrating d and q axes;

FIG. 3 is an equivalent circuit representation of the q-axis of an IPMSM;

FIG. 4 is an equivalent circuit representation of the d-axis of an IPMSM;

FIG. 5 is a functional block diagram of an example of a control system for an asymmetric motor including a current regulating module;

FIG. 6 is a schematic view of an example of the current regulating module of FIG. 5;

FIG. 7 is an example of a three-dimensional surface map plot of q-axis flux versus d-axis current and q-axis current for a certain asymmetrical motor;

FIG. 8 is an example of a three-dimensional surface map plot of d-axis flux versus q-axis current and d-axis current for a certain asymmetrical motor;

FIG. 9 is a functional block diagram of an example of a control system for an asymmetric motor in accordance with an embodiment of the present disclosure; and

FIG. 10 illustrates a method of operating an asymmetrical motor in accordance with an embodiment of the present disclosure.

In the drawings, reference numbers may be reused to identify similar and/or identical elements.

### DETAILED DESCRIPTION

Traditionally, asymmetric motors have been difficult to analyze and tune. Motor control systems are set forth herein, which operate asymmetric motors, such that the asymmetric motors appear symmetric. Motor dynamics are manipulated by setting a time constant versus sampling period ratio and calculating and applying virtual d-axis and q-axis resistance damping values, such that the motor operates similar to a symmetric motor. A couple example symmetric motors are an induction motor and a surface permanent magnet synchronous motor (SPMSM). Controls analysis may be applied for pole placement and controller tuning. This results in a controller (or motor control module) with significantly improved dynamic performance, stiffness, and robustness to, for example, variations in corresponding parameters (e.g., variations in flux, voltage, current, etc.). Other advantages are further described below.

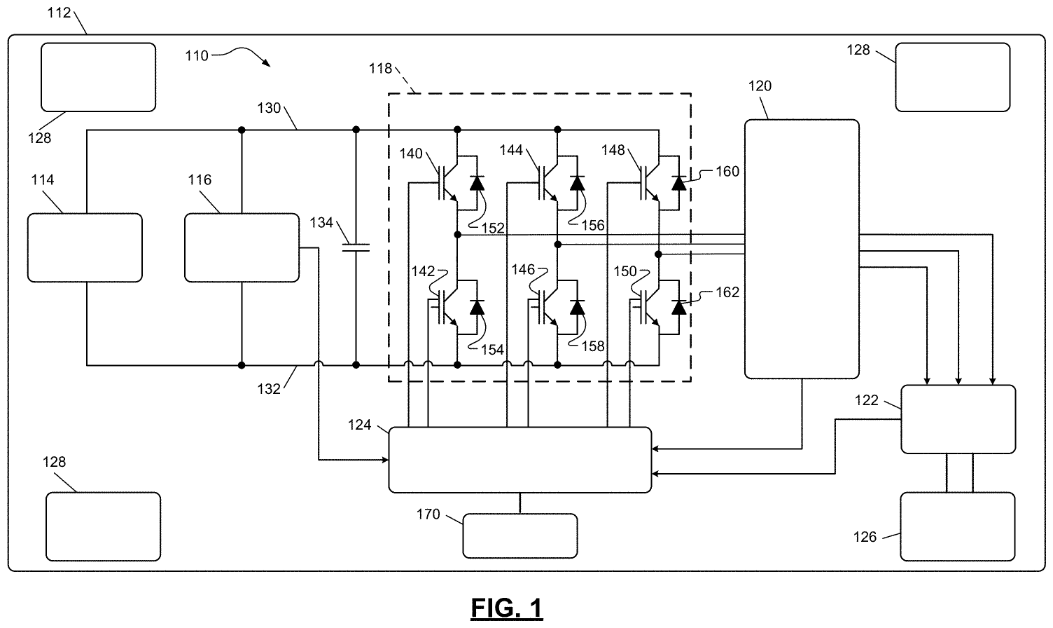

FIG. 1 shows an example of a control system 110 implemented in a vehicle 112 and including a power source 114, a voltage sensor 116, a voltage inverter 118, current sensors 120, an asymmetric motor 122 (e.g., a IPMSM), and a motor control module 124. The motor control module 124 controls operation of the asymmetric motor 122 based on, for example, current supplied to each phase of the asymmetric motor 122, a rotational position of an output shaft of the asymmetric motor 122, and direct current (DC) voltage detected by the voltage sensor 116. The asymmetric motor 122 may rotate, for example, one or more drive wheels (one drive wheel 126 is shown). The asymmetric motor 122 may not drive one or more other wheels 128 (referred to as non-driven wheels). Although the vehicle 112 is shown having a single asymmetric motor, the vehicle may include additional asymmetric motors to drive one or more of the wheels 128.

The power source 114 supplies the DC voltage to voltage line 130. Voltage line 132 may be at a reference voltage or ground potential. The power source 114 and the voltage sensor 116 are connected to the voltage lines 130, 132. The voltage sensor detects a voltage difference between the voltage lines 130, 132. A capacitor 134 may be connected to the voltage lines 130, 132.

The voltage inverter 118 converts the DC voltage potential across the voltage lines 130, 132 to AC voltages, which are supplied to the asymmetric motor. The voltage inverter includes three sets of diode-transistor pairs, where each set includes two transistors connected in series and respective diodes connected in parallel with the corresponding transistor. The voltage inverter 118 includes transistors 140, 142, 144, 146, 148, 150 and diodes 152, 154, 156, 158, 160, 162. The current sensors 120 detect current for each phase output of the voltage inverter 118.

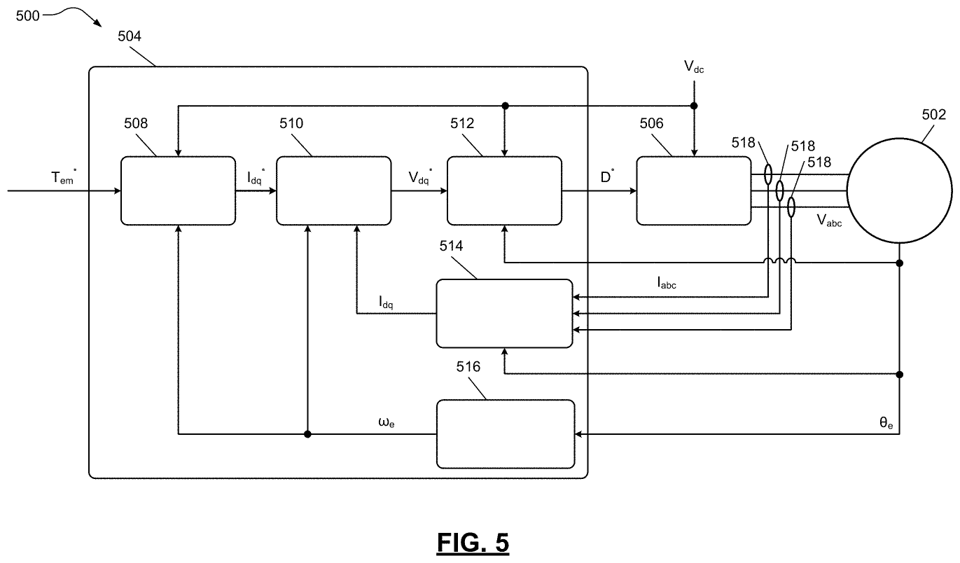

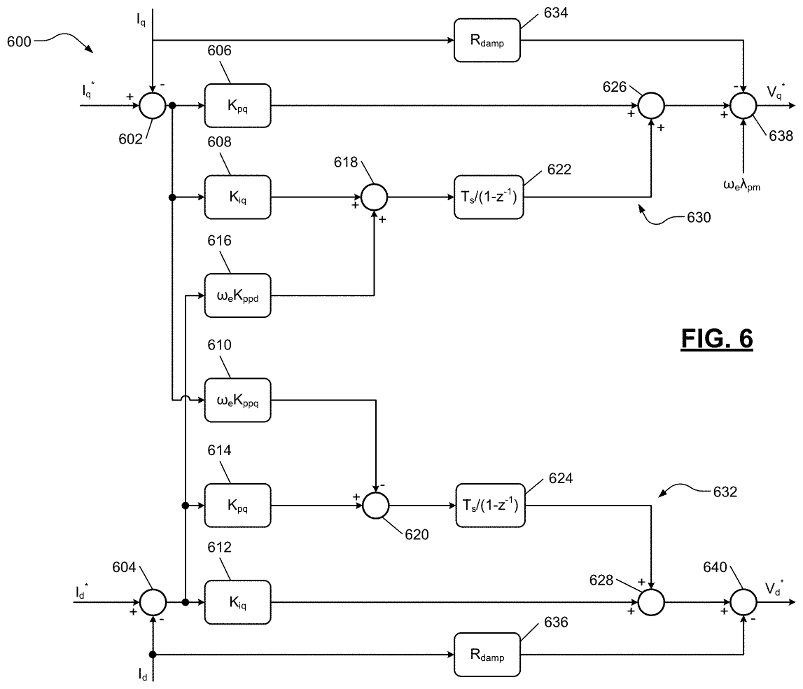

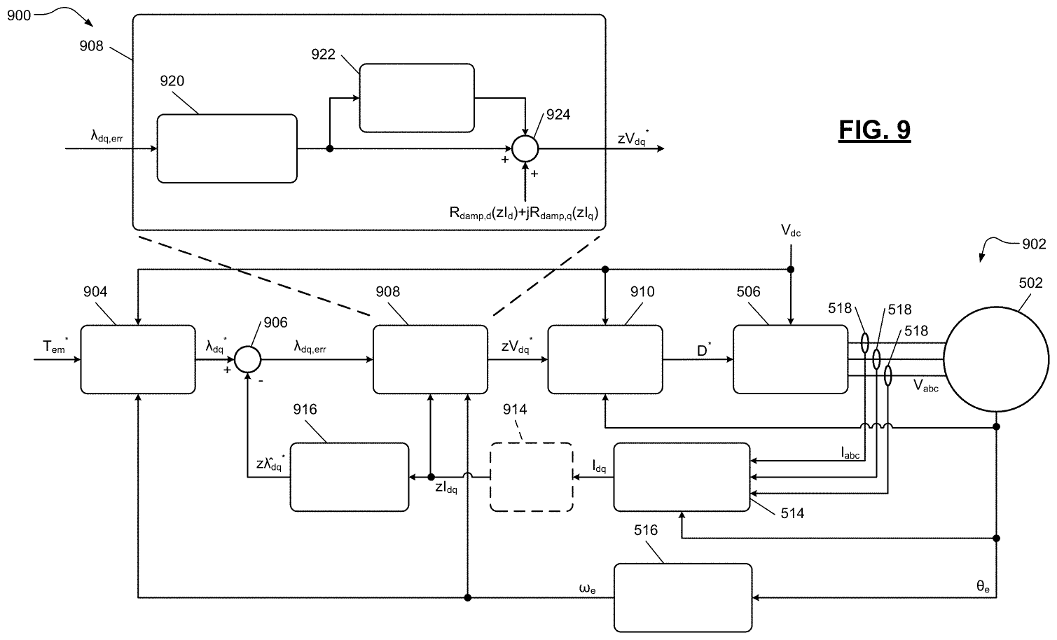

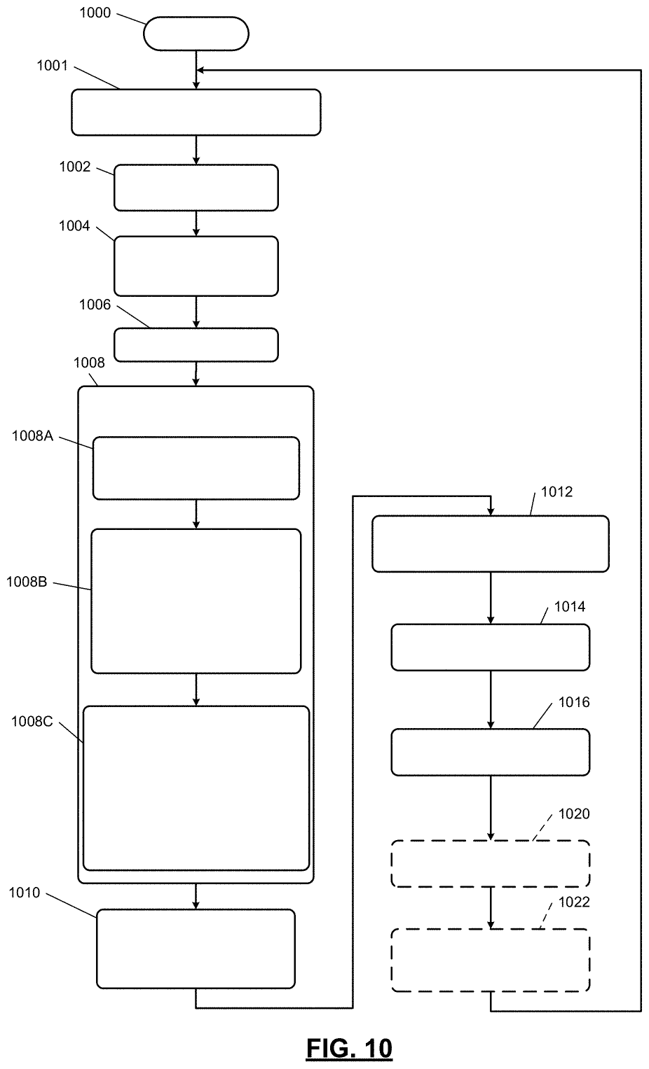

The motor control module 124 generates control signals in the form of pulse width modulation (PWM) signals, which are provided respectively to the transistors 140, 142, 144, 146, 148, 150. The PWM signals are generated based on an output of a regulating module (or regulator). Example regulating modules are shown in FIGS. 5 and 9.

The control system 110 may also include a memory 170, which may be implemented as part of the motor control module 124 or may be separate from the motor control module 124 as shown. The memory 170 may store any of the equations, parameters, variables, look-up-tables, and/or other data and/or signals disclosed herein.

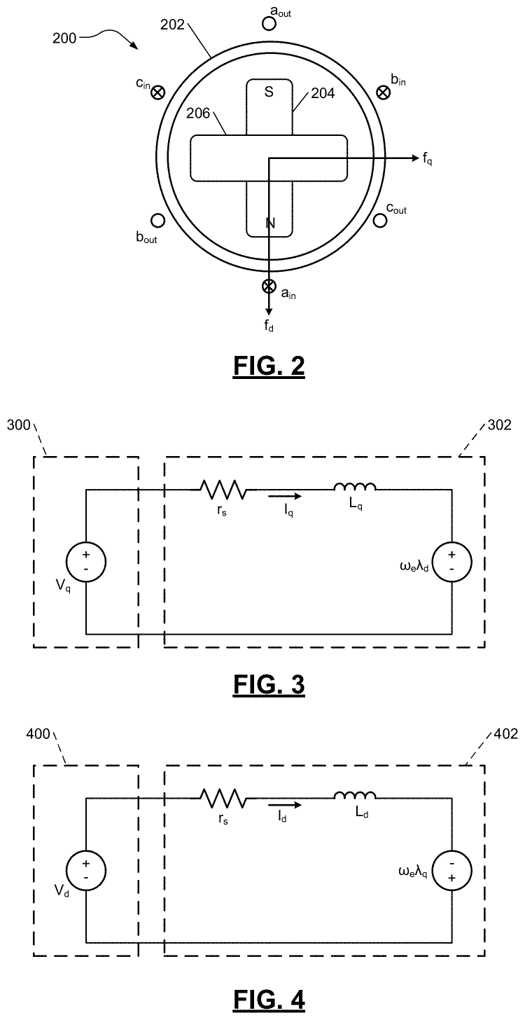

FIG. 2 shows a conceptual diagram of an IPMSM 200 illustrating d and q axes. The IPMSM 200 includes a stator and a rotor. The stator includes 3-phase windings a, b, c, where aᵢₙ, bᵢₙ, cᵢₙ refer to current flow into the page and aₒᵤₜ, bₒᵤₜ, cₒᵤₜ refers to current flow out of the page. The stator may include a cylindrical-shaped barrier 202. The rotor includes permanent magnets (one permanent magnet 204 is shown) and steel 206. The rotor rotates within the stator. The d-axis of the IPMSM 200 is represented by vector f_{d} and the q-axis of the IPMSM 200 is represented by vector f_{q}. The d-axis is an imaginary axis and extends from a center of rotation of the rotor towards a north pole of the permanent magnet 204. The q-axis is a real axis and extends from the center of rotation of the rotor and is electrically and magnetically orthogonal to the d-axis.

FIG. 3 shows q-axis voltage 300 supplied by an inverter and the equivalent circuit of the IPMSM q-axis 302. The inverter provides a voltage V_{q}. In the dq-frame steady-state values are DC, but transient values can have many frequency components. The q-axis 302 of the motor includes a resistance rₛ, an inductance L_{q}, and a back electromotive force (BEMF) cross-coupling voltage source ωₑλ_{d} connected in series, where λ_{d} is the d-axis flux linkage. Current I_{q} flows through the equivalent circuit.

FIG. 4 similarly shows d-axis voltage 400 supplied by an inverter and the equivalent circuit of the IPMSM d-axis 402. The inverter provides a voltage V_{d}. The d-axis 402 of the motor includes a resistance rₛ, an inductance L_{d}, and a BEMF cross-coupling voltage source ωₑλ_{q} connected in series, λ_{q} is the q-axis flux linkage. Current I_{d} flows through the equivalent circuit.

Machine equivalent circuits shown in FIGS. 3 and 4 may be represented by equations 1-2, where ωₑ is the electrical synchronous angular velocity in radians per second.

$$\begin{matrix}{L}_{q} \frac{{dI}_{q}}{dt} = {V}_{q} - {I}_{q} {r}_{s} - {ω}_{e} {λ}_{d} & ( 1 ) \\ {L}_{d} \frac{{dI}_{d}}{dt} = {V}_{d} - {I}_{d} {r}_{s} + {ω}_{e} {λ}_{q} & ( 2 )\end{matrix}$$

Flux linkages (referred to hereinafter as flux) of the d-axis and q-axis may be represented by equations 3 and 4, where λ_{d} is the d-axis flux and λ_{q} is the q-axis flux, where f and g are functions.

λ_{d}=f(I_{d}, I_{q}) (3)

λ_{q}=g(I_{d}, I_{q}) (4)

Torque output of the IPMSM 200 of FIG. 2 may be represented by equation 5, where Tₑ is the output torque and P is the number of pole pairs of the IPMSM 200.

i Tₑ=(3P/2)(λ_{d}I_{q}−λ_{q}I_{d}) (5)

FIG. 5 shows an example of a control system 500 for an asymmetric motor 502. The control system 500 includes a motor control module 504 and a voltage inverter 506. The motor control module 504 includes a current command generation module 508, a current regulating module 510, a switch control module 512, a 3-phase current-to-axis current converting module 514, and an angular position-to-angular velocity converting module 516.

The current command generation module 508 receives a torque command signal Tₑ^{*} and a DC voltage signal V_{dc} and generates a d-axis and q-axis current command signal I_{dq}^{*}. The current regulating module 510 generates a voltage command signal V_{dq}^{*} based on the d-axis and q-axis current command signal I_{d}^{*}, a d-axis and q-axis current signal I_{dq}, and a synchronous angular velocity signal ωₑ. The switch control module 512 generates a duty cycle signal D* based on the voltage command signal V_{dq}, the DC voltage signal V_{dc} and an angular position of the asymmetric motor 502. The voltage inverter 514 generate 3-phase voltage signals V_{abc} based on the duty cycle signal D* and the physical DC voltage applied to the inverter. Current sensors 518 detect current flow for respective phases of the asymmetric motor 502.

The 3-phase current-to-axis current converting module 514 converts current of the 3-phases as detected by the current sensors 518 to the d-axis and q-axis current signal I_{dq}. The angular position-to-angular velocity converting module 516 calculates or estimates the derivative of an angular position θₑ corresponding to the electrical angular position of the rotor of the asymmetric motor 502 to provide the electrical synchronous angular velocity represented by the synchronous angular velocity signal ωₑ.

Although the above stated d-axis and q-axis signals are described as each being a single signal, each of these signals may be represented as two signals a d-axis signal and a q-axis signal. For example, the d-axis and q-axis current command signal I_{dq}^{*} may be represented as a d-axis current command signal I_{d}^{*} and q-axis current command signal I_{q}^{*}. Similarly, the d-axis and q-axis current signal I_{dq} may be represented as a d-axis current signal I_{d} and a q-axis current signal I_{q}. Also, the voltage command signal V_{dq}^{*} may be represented as a d-axis voltage command signal V_{d}^{*} and a q-axis voltage command signal V.

FIG. 6 is a schematic view of an example 600 of the current regulating module 510 of FIG. 5. The current regulating module 510 is a complex vector current regulator and receives the current signals I_{d}, I_{q} and the current command signals I_{d}^{*}, I_{q}^{*} and outputs the voltage command signals V_{d}^{*}, V_{q}^{*}. The example current regulating module 600 includes summers 602, 604 that subtract the current signals I_{d}I_{q} respectively from the current command signals I_{d}^{*}, I_{q}^{*}.

The current regulating module 600 includes gain blocks 606, 608, 610, 612, 614, 616, which multiply gains K_{pq}, K_{iq}, ωₑK_{ppq}, K_{pd}, K_{id}, ωₑK_{ppd} by outputs of the summers 602, 604. A first summer 618 sums outputs of the gain blocks 608, 616. A second summer 620 subtracts an output of the gain block 610 from an output of the gain block 614. The outputs of the summers 618, 620 are integrated by discrete time integrators 622, 624. Outputs of the integrators 622, 624 are summed respectively with outputs of the gain blocks 606, 612 via the summers 626, 628. The gain blocks 606, 608, the summers 618, 626 and the discrete time integrator 622 provide a first proportional integral (PI) loop 630. The gain blocks 612, 614, the summers 620, 628, and the integrator 624 provide a second PI loop 632.

Resistance damping blocks 634, 636 multiply a resistance damping value R_{damp} by each of the current signals I_{d}, I_{q}. Outputs of the resistance damping blocks 634, 636 are subtracted via summers 638, 640 and respectively from the outputs of the summers 626, 628 to provide the voltage command signals V_{d}^{*}, V_{q}^{*}.

Current regulator tuning, using the control system 500 of FIG. 5 and the current regulating module 600 of FIG. 6, is complicated and parameter sensitive. It can be difficult to determine: when to use static versus transient inductance; how to calculate static versus transient inductances; and how to tune the resistance damping blocks 634, 636 (i.e., the corresponding resistance damping value R_{damp}). In addition, tuning for the d-axis and the q-axis is different due to asymmetric inductance of the corresponding asymmetric motor.

The following examples provide a control system that controls an asymmetric motor in such a manner that the asymmetric motor, with respect to a regulating module, operates as a symmetric motor. The examples simplify regulating control, eliminate static versus transient inductance concerns, provide the same tuning for both the d-axis and q-axis of an asymmetric motor, and improve regulating performance and robustness as further described below.

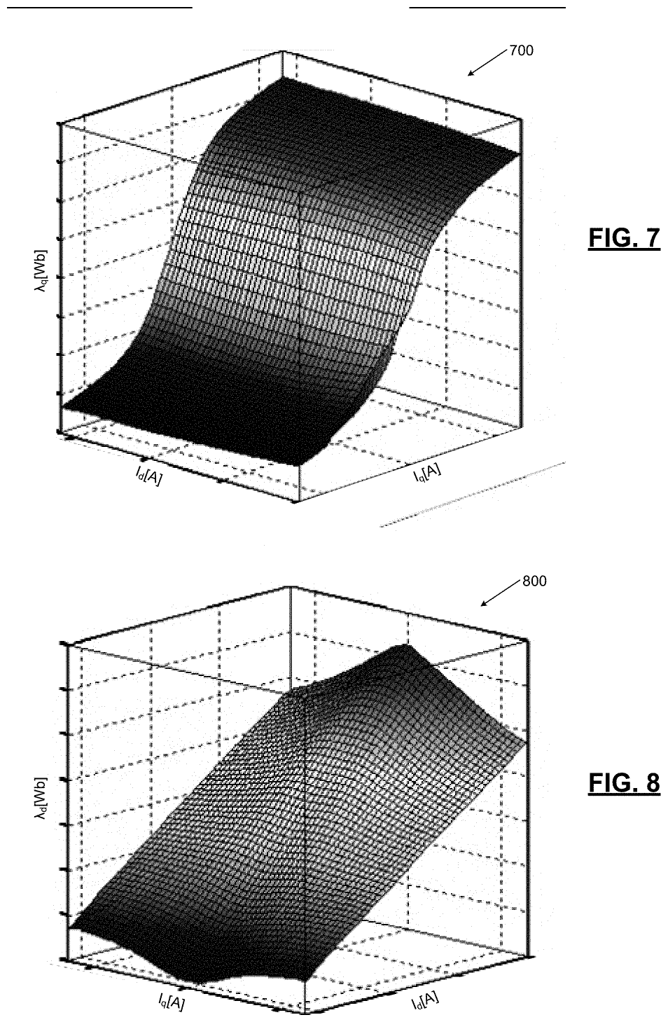

The following examples are based on the understanding that relationships between flux of an asymmetric motor and d-axis current and q-axis current levels are not two-dimensional, but are actually three-dimensional. FIGS. 7 and 8 show three-dimensional surface map plots 700, 800 (referred to as flux maps) of (i) a q-axis flux λ_{q} versus d-axis current and q-axis current for a certain asymmetrical motor, and (ii) a corresponding d-axis flux λ_{d} versus q-axis current and d-axis current for the same asymmetrical motor. Although the q-axis flux λ_{q} changes primarily due to change in q-axis current, the q-axis flux λ_{q} also changes based on change in d-axis current. Similarly, although d-axis flux λ_{d} changes primarily due to change in d-axis current, the d-axis flux λ_{d} also changes based on change in q-axis current. The units of measure for the q-axis flux λ_{q} and the d-axis flux λ_{d} is Webers (Wb) and the units of measure for the q-axis current and d-axis current is Amperes (A). Transient inductances of the asymmetric motor correspond to local slopes of the surface map plots 700 and/or 800. The static inductance is equal to the flux divided by the corresponding axis current.

Alternative forms of equations 1 and 2 above are provided below as machine equations 6 and 7.

$$\begin{matrix}\frac{d}{dt} {λ}_{q} = {V}_{q} - {Ri}_{q} - {ω}_{e} {λ}_{d} = {f}_{1} & ( 6 ) \\ \frac{d}{dt} {λ}_{d} = {V}_{d} - {Ri}_{d} + {ω}_{e} {λ}_{q} = {f}_{2} & ( 7 )\end{matrix}$$

Equations 6 and 7 may be linearized about an operating point using an operating point model represented by equations 8 and 9. This includes taking a partial derivative of a function with respect to each variable.

$$\begin{matrix}Δ {f}_{1} = \frac{d}{dt} {Δλ}_{q} = Δ {V}_{q} \frac{\partial {f}_{1}}{\partial {V}_{q}} {}_{op} + Δ {i}_{q} \frac{\partial {f}_{1}}{\partial {i}_{q}} {}_{op} + {Δλ}_{d} \frac{\partial {f}_{1}}{\partial {λ}_{d}} {}_{op} & ( 8 ) \\ Δ {f}_{2} = \frac{d}{dt} {Δλ}_{d} = Δ {V}_{d} \frac{\partial {f}_{2}}{\partial {V}_{d}} {}_{op} + Δ {i}_{d} \frac{\partial {f}_{1}}{\partial {i}_{d}} {}_{op} + {Δλ}_{q} \frac{\partial {f}_{2}}{\partial {λ}_{q}} {}_{op} & ( 9 )\end{matrix}$$

The resulting linearized machine equations are equations 10 and 11.

$$\begin{matrix}\frac{d}{dt} {Δλ}_{q} = Δ {V}_{q} - R Δ {i}_{q} - {ω}_{e} {Δλ}_{d} & ( 10 ) \\ \frac{d}{dt} {Δλ}_{d} = Δ {V}_{d} - R Δ {i}_{d} - {ω}_{e} {Δλ}_{q} & ( 11 )\end{matrix}$$

Equations 10 and 11 are small signal representations of the machine equations 6 and 7 using small signal analysis.

The q-axis and d-axis current levels may be defined as a function of the d-axis and q-axis flux, as represented by equations 12 and 13, which have corresponding surface flux maps of I_{d} and versus λ_{d} and λ_{q} and f and g are functions. In equations 12 and 13, the three-dimensional maps in FIGS. 7 and 8 are used in an inverse manner, such that certain flux levels provide certain current levels.

I_{q}=f(λ_{d},λ_{q}) (12)

I_{d}=g(λ_{d},λ_{q}) (13)

Solving for Δl_{q} and ΔI_{d} using small signal analysis and the surfaces corresponding to equations 12 and 13 provides equations 14 and 15, where changes in current are defined as a function of changes in flux. This provides a relationship between a small signal change in current relative to a small signal change in flux.

$$\begin{matrix}Δ {I}_{q} = \frac{\partial {I}_{q}}{\partial {λ}_{q}} {Δλ}_{q} + \frac{\partial {I}_{q}}{\partial {λ}_{d}} {Δλ}_{d} & ( 14 ) \\ Δ {I}_{d} = \frac{\partial {I}_{d}}{\partial {λ}_{q}} {Δλ}_{q} + \frac{\partial {I}_{d}}{\partial {λ}_{d}} {Δλ}_{d} & ( 15 )\end{matrix}$$

The right sides of equations 14 and 15 may be plugged into equations 10 and 11 to provide the following linear machine equations 16 and 17 in a flux format.

$$\begin{matrix}\frac{d}{dt} {Δλ}_{q} = Δ {V}_{q} - R ( \frac{\partial {I}_{q}}{\partial {λ}_{q}} {Δλ}_{q} + \frac{\partial {I}_{q}}{\partial {λ}_{d}} {Δλ}_{d} ) - {ω}_{e} {Δλ}_{d} & ( 16 ) \\ \frac{d}{dt} {Δλ}_{d} = Δ {V}_{d} - R ( \frac{\partial {I}_{d}}{\partial {λ}_{q}} {Δλ}_{q} + \frac{\partial {I}_{d}}{\partial {λ}_{d}} {Δλ}_{d} ) + {ω}_{e} {Δλ}_{q} & ( 17 )\end{matrix}$$

Equations 16 and 17 are not a function of current. The partial derivative terms

$$\frac{\partial {I}_{q}}{\partial {λ}_{q}} , \frac{\partial {I}_{q}}{\partial {λ}_{d}} , \frac{\partial {I}_{d }}{\partial {λ}_{q}} and \frac{\partial {I}_{d}}{\partial {λ}_{d}}$$

of equations 16 and 17 are directly related to an inverse of inductance (or 1/inductance) and may be calculated from the surface maps of FIGS. 7 and 8. When these inverse flux terms are multiplied by resistance as shown in equations 16 and 17 the result are resistance-over-inductance time constants. These time constants can be expressed as

$$\frac{1}{{τ}_{qq}} , \frac{1}{{τ}_{qd}} , \frac{1}{{τ}_{dd}} and \frac{1}{{τ}_{dq}} .$$

In addition, since the values of

$$\frac{1}{{τ}_{qd}} and \frac{1}{{τ}_{dq}}$$

are small compared to the values of

$$\frac{1}{{τ}_{qq}} and \frac{1}{{τ}_{dd}}$$

and become increasingly negligible as speed of the asymmetric motor increases, equations 16 and 17 may be simplified to provide equations 18 and 19.

$$\begin{matrix}\frac{d}{dt} {Δλ}_{q} = Δ {V}_{q} - \frac{1}{{τ}_{qq}} {Δλ}_{q} - {ω}_{e} {Δλ}_{d} & ( 18 ) \\ \frac{d}{dt} {Δλ}_{d} = Δ {V}_{d} - \frac{1}{{τ}_{dd}} {Δλ}_{d} + {ω}_{e} {Δλ}_{q} & ( 19 )\end{matrix}$$

Utilizing asymmetric virtual damping resistances, the time constants

$$\frac{1}{{τ}_{qq}} and \frac{1}{{τ}_{dd}}$$

may be virtually modified by the control module to provide a single modified time constant

$$\frac{1}{{τ}_{mod}}$$

as represented by equation 20. The asymmetric virtual damping resistances R_{damp.d} and R_{damp.q} are used to make the corresponding control module and/or regulating module operate as though the asymmetric motor has a modified resistance, which is greater than an actual resistance of the asymmetric motor.

$$\frac{1}{{τ}_{mod}} = ( R + {R}_{damp \cdot q} ) \frac{\partial {I}_{q}}{\partial {λ}_{q}} = ( R + {R}_{damp \cdot d} ) \frac{\partial {I}_{d}}{\partial {λ}_{d}} \qquad ( 20 )$$

Calibration is performed to set τ_{mod} and the algorithm solves for virtual damping resistances R_{damp.q}, R_{damp.d}. As a result, equations 18 and 19 are modified to provide symmetric machine equations 21 and 22, which are based on flux and the modified time constant.

$$\begin{matrix}\frac{d}{dt} {Δλ}_{q} = Δ {V}_{q} - \frac{1}{{τ}_{mod}} {Δλ}_{q} - {ω}_{e} {Δλ}_{d} & ( 21 ) \\ \frac{d}{dt} {Δλ}_{d} = Δ {V}_{d} - \frac{1}{{τ}_{mod}} {Δλ}_{d} + {ω}_{e} {Δλ}_{q} & ( 22 )\end{matrix}$$

After utilizing asymmetric virtual damping according to equation 20, equations 21 and 22 display that the asymmetric motor has been virtually modified to appear as a symmetric motor to the control module.

Equations 21 and 22 may be converted to the Laplace domain (or s-domain) and written in a single vector format to provide equation 23, where j is the complex axis notation.

$${G}_{p} ( s ) = \frac{{λ}_{dq} ( s )}{{V}_{dq} ( s )} = \frac{1}{s + {τ}_{mod}^{- 1} + j {ω}_{e}} \qquad ( 23 )$$

Using the closed loop transfer function for a complex vector controller as represented by equation 24 provides closed loop transfer function equation 25 which displays the potential for pole-zero cancellation.

$$\begin{matrix} {G}_{c} ( s ) = \frac{{V}_{dq}}{( {λ}_{dq}^{*} - {λ}_{dq} )} = {K}_{p} + \frac{{K}_{i} + {jK}_{p} {ω}_{e}}{s} & ( 24 ) \\ \frac{{λ}_{dq}}{{λ}_{dq}^{*}} = \frac{s}{s} \cdot \frac{{G}_{c} {G}_{p}}{( 1 + {G}_{c} {G}_{p} )} = \frac{{K}_{p} ( s + \frac{{K}_{i}}{{K}_{p}} + j {ω}_{e} ) ( \frac{1}{s + {τ}_{mod}^{- 1} + j {ω}_{e}} )}{s + {K}_{p} ( s + \frac{{K}_{i}}{{K}_{p}} + j {ω}_{e} ) ( \frac{1}{s + {τ}_{mod}^{- 1} + j {ω}_{e}} )} & ( 25 )\end{matrix}$$

Tuning is provided by selecting a ratio Kₑ, which is equal to the modified time constant τ_{mod} divided by a sampling period Tₛ by which, for example flux or current is sampled and provided as a feedback parameter. In other words, a target time constant τ_{mod} is calculated based on the desired ratio of

$$\frac{{τ}_{mod}}{{T}_{s}}$$

set by Kₑ. The virtual damping resistances are then calculated using equations 26 and 27 and based on current versus flux maps, such as the inverse of the maps shown in FIGS. 7 and 8, where Rₛ is actual resistance of the asymmetric motor.

$$\begin{matrix}{R}_{damp \cdot d} = {( \frac{\partial {I}_{d}}{\partial {λ}_{d}} )}^{- 1} {τ}_{mod}^{- 1} - {R}_{s} & ( 26 ) \\ {R}_{damp \cdot q} = {( \frac{\partial {I}_{q}}{\partial {λ}_{q}} )}^{- 1} {τ}_{mod}^{- 1} - {R}_{s} & ( 27 )\end{matrix}$$

Regulating module bandwidth ω_{b} is then selected and the gain Kₚ is set equal to ω_{b}, which is the same for both d and q axes. The bandwidth ω_{b} is a frequency in radians per second. Tuned pole/zero cancellation is provided by setting the gain Kᵢ=Kₚτ_{mod}⁻¹, which is also the same for both d and q axes.

Based on the above equations 21-23 and 25-27, a control system 900 and corresponding modified plant 902 of FIG. 9 are provided. The control system 900 is flux based, not current based and includes a flux command generation module 904, a summer 906, a regulating module (or regulator) 908, a switch control module 910, the 3-phase current-to-axis current converting module 514 the angular position-to-angular velocity converting module 516, a current module 914, and a current-to-flux converting module (or current-to-flux converter) 916. In one embodiment, the current module 914 is not included and an output of the 3-phase current-to-axis current converting module 914 is provided directly to the regulating module 908 and the current-to-flux converting module 916. A portion or all of the control system 900 may be implemented in the motor control module 124 of FIG. 1. The regulating module 908 includes a proportional flux error-to-voltage converting module 920, a complex integration module 922 and a summer 924. Operation of the control system is described with respect to FIGS. 9 and 10.

In FIG. 10, a method of operating an asymmetrical motor (e.g., the asymmetric motor 122 of FIG. 1) is shown. Although the following operations are primarily described with respect to the implementations of FIGS. 1, 9 and 10, the operations may be easily modified to apply to other implementations of the present disclosure. The operations may be iteratively performed. Various signals are described below and indicate values of a respective variable/parameter. Also, although single signals are shown and refer to both the d-axis and q-axis, separate signals may be provided for each of the d-axis and q-axis, as similarly stated above. The method may begin at 1000. At 1001, the motor control module 124 and/or the regulating module 908 calculates the modified time constant τ_{mod}, which is represented by equation 28 and damping resistance values represented by equations 29 and 30.

$$\begin{matrix}{τ}_{mod} = {K}_{e} \cdot {T}_{s} & ( 28 ) \\ {R}_{damp \cdot d} = {( \frac{\partial {I}_{d}}{\partial {λ}_{d}} )}^{- 1} {τ}_{mod}^{- 1} - {R}_{s} & ( 29 ) \\ {R}_{damp \cdot q} = {( \frac{\partial {I}_{q}}{\partial {λ}_{q}} )}^{- 1} {τ}_{mod}^{- 1} - {R}_{s} & ( 30 )\end{matrix}$$

At 1002, a torque command signal Tₑₘ^{*} is generated. The torque command signal may be generated based on, for example, load requests to change speed and/or acceleration of a vehicle (e.g., the vehicle 112).

At 1004, the flux command generation module 904 generates a flux command signal λ_{dq}^{*}, which is a function of the torque command signal Tₑₘ^{*}, and may depend on motor speed, and the inverter DC voltage. In one embodiment, values of the flux command signal λ_{dq}^{*} are determined using a look-up-table (LUT) that relates values of commanded torque to values of commanded flux.

At 1006, the summer 906 determines an error in flux λ_{dq,err} by subtracting flux of a current sample λ_{dq} or of a next estimated current sample z·\hat{λ}_{dq} to provide the flux error λ_{dq,err}, where z refers to a one sample instant advance (i.e., one time sample in the future).

At 1008, the regulating module 908 generates a commanded voltage signal z·V_{dq}^{*} corresponding to the voltage to be applied over the next sample period. At 1008A, the proportional flux error-to-voltage converting module 920 multiplies bandwidth ω_{b} by λ_{dq,err} to provide a proportional voltage term, which is provided to the complex integration module 922 and the summer 924. At 1008B, the complex integration module 922 applies a complex gain to the proportional voltage term followed by discrete integration of the result to provide an integral voltage term, referred to as a discrete integration process. Therefore, module 922 may be represented as

$$\frac{( {τ}_{mod}^{- 1} + j {ω}_{e} ) {T}_{s}}{1 - {z}^{- 1}}$$

in the discrete domain (or z-domain).

At 1008C, the summer 924 sums (i) the proportional voltage term, (ii) the integral voltage term and (iii) a sum of (a) the d-axis damping resistance voltage I_{d}·R_{damp,d} and (b) a product of j and the q-axis damping resistance voltage I_{q}·R_{damp,q} to provide the voltage command signal z·V_{dq}^{*}, wherein the damping resistance voltages may be determined using equations 29 and 30. In one embodiment, when the current module 914 is included, the summer 924 sums (i) the proportional voltage term, (ii) the integral voltage term and (iii) a sum of (a) the d-axis damping resistance voltage z·I_{d}·R_{damp,d} and (b) a product of j and the q-axis damping resistance voltage z·I_{q}·R_{damp,q} based on the next estimated sample current z·I_{d} of the d-axis and next estimated sample current z·I_{q} of the q-axis to provide the voltage command signal z·V_{dq}^{*}, where j is complex axis notation for a complex number.

At 1010, the switch control module 910 generates pulse width modulating signals to control, for example, the switches 140, 142, 144, 146, 148, 150 of FIG. 1. At 1012, a voltage inverter (e.g., the voltage inverter 118 or 506) generates AC voltage signals (e.g., V_{abc}), which are provided to the asymmetric motor. At 1014, the asymmetric motor is operated based on the output voltage signals. As a result of generating the voltage command signal described above, the asymmetric motor is operated in a symmetric manner and has the corresponding modified plant 902 represented as

$$\frac{1}{s + {τ}_{mod}^{- 1} + j {ω}_{e}} .$$

At 1016, the current may be sampled for one or more phases of the asymmetric motor using, for example, the current sensors 120. The current I_{dq} may be determined based on the sampled current and rotor angular position. At 1020, the current module 914, when included, estimates a current level of a next current sample. The next current sample is represented as current signal z·I_{dq}. At 1022, the current-to-flux converting module 916 converts the current I_{dq} or the current z·I_{dq} to flux, which are represented respectively as λ_{dq} and z·\hat{λ}_{dq}. The λ_{dq} (or z·\hat{λ}_{dq}) is a function of the current I_{dq} (or z·I_{dq}) and may be determined using a LUT relating values of the flux λ_{dq} (or z·\hat{λ}_{dq}) to values of the current I_{dq} (or z·I_{dq}). Operation 1001 may be performed subsequent to operation 1022. One or more of operations 1001, 1002, 1004, 1006, 1008, 1012, 1014, 1016, 1020, 1022 may be performed every sample period. For example, if the sampling period is changing, then based on equation (28) a new time constant τ_{mod} is calculated and new damping resistance values are used. This should be updated in FIG. 10. The signals output by the modified plant 902 and the modules 912, 914, 916 may be referred to as feedback signals.

The above-described operations are meant to be illustrative examples. The operations may be performed sequentially, synchronously, simultaneously, continuously, during overlapping time periods or in a different order depending upon the application. Also, any of the operations may not be performed or skipped depending on the implementation and/or sequence of events.

The above-disclosed method improves current and torque regulation, dynamic performance, and robustness of an asymmetric motor. This is achieved by virtually manipulating d and q axes time constants of a plant to achieve a virtually symmetric machine (or motor). Individual virtual damping resistances for d and q axes are determined. Resistance damping values are used to target a set ratio of plant time constant and a sample frequency. The time constant is selected to provide a virtually symmetric machine. The corresponding regulation is performed based on flux, referred to as the flux domain.

By using a same time constant to sample period ratio for both d and q axes, performance and dynamic torque response is not negatively affected as compared to operating an asymmetric motor based on different time constant to sampling period ratios for the d and q axes. Also, by using the same time constant to sample period ratio for both d and q axes, increased damping resistance can be provided, which decreases sensitivity and increases operating stiffness. Since the disclosed control system has decreased sensitivity, the control system is robust to parameter inaccuracies, such as inaccuracies in inductance, resistance, flux, etc. of an asymmetric motor. Stiffness refers to how a regulating module responds to disturbances. The higher the stiffness, the better the response to disturbances or, in other words, the better the rejection of disturbances to prevent negatively affecting performance. The disclosed regulating module of FIG. 9 modifies the damping resistance to achieve improved dynamic performance. Regulation tuning is simplified by adjustment of the time constant and static and transient inductance is not a concern. Tuning of the damping resistance values is accomplished without estimation or trial and error guessing of an appropriate damping resistance. There is also no need to estimate or guess a tuning relationship between the damping resistance and bandwidth, which can be common with traditional control systems.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A control system for controlling operation of an asymmetric motor to operate as a symmetric motor, the control system comprising:
a memory configured to store a time constant, a first damping resistance for a d-axis of the asymmetric motor, and a second damping resistance for a q-axis of the asymmetric motor;
a first summer configured to determine a flux error for the d-axis and the q-axis of the asymmetric motor based on a commanded flux value and a feedback flux value;
a proportional flux error-to-voltage converter configured to convert the flux error to a proportional voltage term;
a complex integration module configured to, based on the time constant, a synchronous angular velocity of the asymmetric motor, and a sampling period, calculate an integral voltage term;
a second summer configured to sum the proportional voltage term, the integral voltage term, and a damping resistance voltage to generate a voltage command signal, wherein the damping resistance voltage is based on the first damping resistance and the second damping resistance; and
a control module configured to control operation of the asymmetric motor based on the voltage command signal.

2. The control system of claim 1, further comprising a regulator configured to calculate the time constant based on the sampling period for sampling current or flux of the asymmetric motor, wherein the regulator comprises the proportional flux error-to-voltage converter, the complex integration module, and the second summer.

3. The control system of claim 1, further comprising a regulator configured to calculate the damping resistance voltage based on at least one of the time constant, an amount of current associated with the d-axis, an amount of current associated with the q-axis, one or more partial derivatives of surface flux maps, an amount of flux associated with the d-axis, an amount of flux associated with the q-axis, or an actual resistance of the asymmetric motor, wherein the regulator comprises the proportional flux error-to-voltage converter, the complex integration module, and the second summer.

4. The control system of claim 1, further comprising a regulator configured to calculate the damping resistance voltage based on the time constant, an amount of current associated with the d-axis, an amount of current associated with the q-axis, an amount of flux associated with the d-axis, an amount of flux associated with the q-axis, and an actual resistance of the asymmetric motor, wherein the regulator comprises the proportional flux error-to-voltage converter, the complex integration module, and the second summer.

5. The control system of claim 1, wherein the control module is configured to operate the asymmetric motor to provide a modified plant representation of the asymmetric motor of
$$\frac{1}{s + {τ}_{mod}^{- 1} + j {ω}_{e}}$$
in the Laplace domain, where τ_{mod} is the time constant and ωₑ is the synchronous angular velocity.

6. The control system of claim 1, wherein the proportional flux error-to-voltage converter is configured to generate the proportional voltage term based on a preselected bandwidth.

7. The control system of claim 1, wherein:
the complex integration module is configured to modify the proportional voltage term by an amount of gain and discrete integration process; and
the amount of gain is based on the time constant, the synchronous angular velocity and the sampling period.

8. The control system of claim 1, wherein:
the control module is configured to operate the asymmetric motor based on a first flux based linearized machine equation for the d-axis and a second flux based linearized equation for the q-axis; and
the first flux based linearized machine equation and the second flux based linearized equation are in a same form as symmetric machine equations.

9. The control system of claim 1, further comprising a regulator configured to regulate operation of the asymmetric motor using a same time constant to sampling period ratio for each of the d-axis and the q-axis,
wherein the regulator comprises the proportional flux error-to-voltage converter, the complex integration module, and the second summer.

10. The control system of claim 1, further comprising:
a current module configured to estimate an amount of d and q axes current for a next sample time subsequent to a current sample time; and
a current-to-flux converter configured to convert the estimated amount of d and q axes current to the feedback flux value, where the feedback flux value is an amount of flux for the d and q axes.

11. A method of controlling operation of an asymmetric motor to operate as a symmetric motor, the method comprising:
calculating a time constant, a first damping resistance for a d-axis of the asymmetric motor, and a second damping resistance for a q-axis of the asymmetric motor;
determining a flux error for the d-axis and the q-axis of the asymmetric motor based on a commanded flux value and a feedback flux value;
converting the flux error to a proportional voltage term;
based on the time constant, a synchronous angular velocity of the asymmetric motor, and a sampling period, modifying the proportional voltage term to provide an integral voltage term;
summing the proportional voltage term, the integral voltage term, and a damping resistance voltage to generate a voltage command signal, wherein the damping resistance voltage is based on the first damping resistance and the second damping resistance; and
controlling operation of the asymmetric motor based on the voltage command signal.

12. The method of claim 11, comprising calculating the time constant based on the sampling period for sampling current or flux of the asymmetric motor.

13. The method of claim 11, comprising calculating the damping resistance voltage based on at least one of the time constant, an amount of current associated with the d-axis, an amount of current associated with the q-axis, one or more partial derivatives of surface flux maps, an amount of flux associated with the d-axis, an amount of flux associated with the q-axis, or an actual resistance of the asymmetric motor.

14. The method of claim 11, comprising calculating the damping resistance voltage based on the time constant, an amount of current associated with the d-axis, an amount of current associated with the q-axis, an amount of flux associated with the d-axis, an amount of flux associated with the q-axis, and an actual resistance of the asymmetric motor.

15. The method of claim 11, further comprising operating the asymmetric motor to provide a modified plant representation of the asymmetric motor of
$$\frac{1}{s + {τ}_{mod}^{- 1} + j {ω}_{e}}$$
in the Laplace domain, where τ_{mod} is the time constant and u is the synchronous angular velocity.

16. The method of claim 11, further comprising generating the proportional voltage term based on a preselected bandwidth.

17. The method of claim 11, comprising modifying the proportional voltage term by an amount of gain and discrete integration process,
wherein the amount of gain is based on the time constant, the synchronous angular velocity and the sampling period.

18. The method of claim 11, further comprising operating the asymmetric motor based on a first flux based linearized machine equation for the d-axis and a second flux based linearized equation for the q-axis,
wherein the first flux based linearized machine equation and the second flux based linearized equation are in a same form as symmetric machine equations.

19. The method of claim 11, further comprising regulating operation of the asymmetric motor using a same time constant to sampling period ratio for each of the d-axis and the q-axis.

20. The method of claim 11, further comprising:
estimating an amount of d and q axes current for a next sample time subsequent to a current sample time; and
converting the estimated amount of d and q axes current to the feedback flux value, where the feedback flux value is an amount of flux for the d and q axes.
